(19) United States
(12) Patent Application Publication
(10) Pub. No.: US 2025/0326226 A1
(43) Pub. Date: Oct. 23, 2025

(54) PRINTER DEVICE

(71) Applicant: Roland DG Corporation, Hamamatsu-shi, Shizuoka (JP)

(72) Inventors: Kazuki INO, Hamamatsu-shi (JP); Hiroshi OKUNO, Hamamatsu-shi (JP); Sho MATSUNAGA, Hamamatsu-shi (JP)

(21) Appl. No.: 18/701,747

(22) PCT Filed: Nov. 29, 2022
(86) PCT No.: PCT/JP2022/044031

§ 371 Date: Sep. 25, 2024

(30) Foreign Application Priority Data
Dec. 14, 2021 (WO) PCT/JP2021/046111

(51) Int. Cl. B41J 2/165

(52) U.S. Cl. CPC B41J 2/16507; B41J 2/16502; B41J 2/16544; B41J 2/16579

(57) ABSTRACT

A printer device (10) includes a base portion (23); an ink discharge unit (30) which is provided on the base portion (23) and to which ink is discharged; and a lid that covers (40) the ink discharge unit (30). The ink discharge unit (30) includes an ink absorbing member (32) capable of absorbing the discharged ink. The lid (40) includes an opening (41a) formed to allow at least a part of the ink absorbing member (32) to be exposed, and is provided to be swingable with respect to the ink absorbing member (32). Preferably, the base portion (23) is provided with a magnet (27) capable of coming into close contact with the lid (40) to keep the lid (40) in a closed state.

### TECHNICAL FIELD

The present invention relates to a printer device including an ink discharge unit to which ink is discharged.

### BACKGROUND ART

A printer device includes an ejection unit that ejects ink, and printing is performed on a medium by ejecting ink from the ejection unit toward the medium. The ink adhering to the ejection unit dries and can be a cause of clogging. For this reason, some printer devices include an ink discharge unit to which the ink is discharged. The clogging of the ejection unit is suppressed by ejecting the ink from the ejection unit to the ink discharge unit in a predetermined case. As a conventional technique related to such a printer device, there is a technique disclosed in Patent Document 1.

The printer device disclosed in Patent Document 1 includes an ejection unit (head unit) that ejects ink, and an ink discharge unit (idle ejection receiver) to which the ink is discharged from the ejection unit.

An ink absorbing member that absorbs the ink is provided inside the ink discharge unit, and absorbs the ink ejected from the ejection unit. The ink absorbing member is generally fixed by a lid using screws or the like.

### CITATION LIST

### Patent Document

Patent Document 1: Japanese Unexamined Patent Publication No. 2020-44826

### SUMMARY OF THE INVENTION

### Problem to be Solved by the Invention

In the printer device disclosed in Patent Document 1, when a certain amount of the ink is discharged to the ink discharge unit, the replacement of the ink absorbing member is required. At this time, when the lid is fixed using screws or the like, maintenance work becomes complicated.

An object of the invention is to provide a printer device with high maintainability.

### Means for Solving Problem

According to the invention, there is provided a printer device including a base portion; an ink discharge unit which is provided on the base portion and to which ink is discharged; and a lid that covers the ink discharge unit. The ink discharge unit includes an ink absorbing member capable of absorbing the discharged ink. The lid includes an opening formed to allow at least a part of the ink absorbing member to be exposed, and is provided to be swingable with respect to the ink absorbing member.

### Effect of the Invention

According to the invention, it is possible to provide the printer device with high maintainability.

### BRIEF DESCRIPTION OF DRAWINGS

FIG. 1 is a front view of a printer device according to a first embodiment;

FIG. 2 is a perspective view of an ink discharge unit and a lid mounted in the printer device illustrated in FIG. 1;

FIG. 3 is a perspective view of the ink discharge unit when the lid illustrated in FIG. 2 is in an open state;

FIG. 4 is a perspective view describing a detection unit illustrated in FIG. 3;

FIG. 5 is a plan view of a printer device according to a second embodiment;

FIG. 6 is a perspective view of a lid illustrated in FIG. 5; and

FIG. 7 is a view describing an action of the printer device illustrated in FIG. 5.

### MODES FOR CARRYING OUT THE INVENTION

Modes for implementing the invention will be described below based on the accompanying drawings.

### First embodiment

Configuration of Printer Device 10

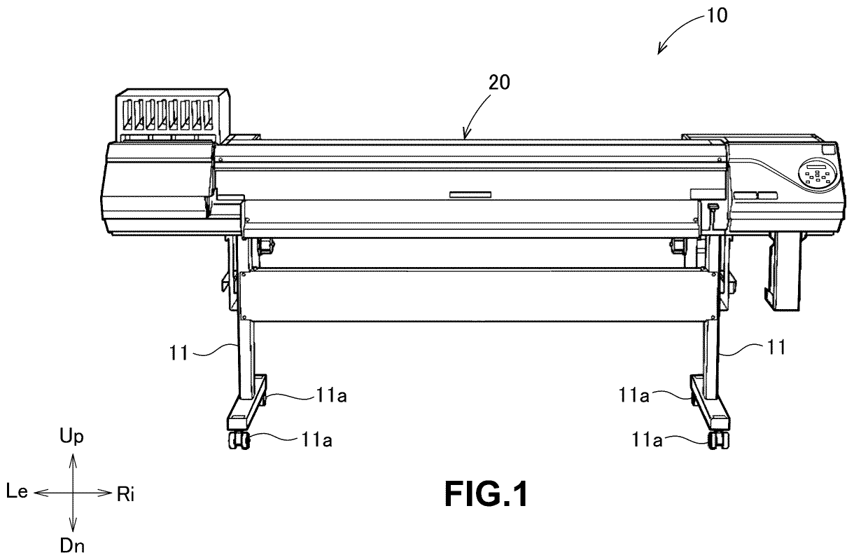

Referring to FIG. 1, a printer device 10 is, for example, a printer called a UV printer using an ultraviolet curable ink. The UV printer is capable of curing the ink in a short time by irradiating the ink with ultraviolet rays while ejecting the ink onto a medium that is a print target.

The printer device 10 includes, as main components, legs 11 in which casters 11a are provided at lower portions and which are movable, and a print unit 20 supported by the legs 11 and capable of performing printing on the medium.
Configuration of Print Unit 20

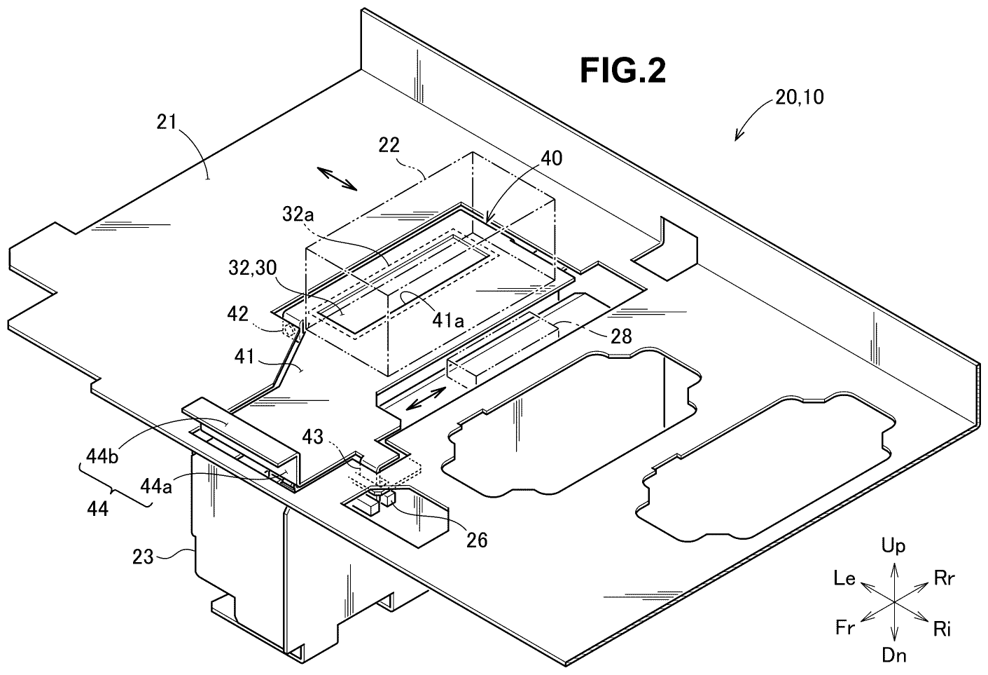

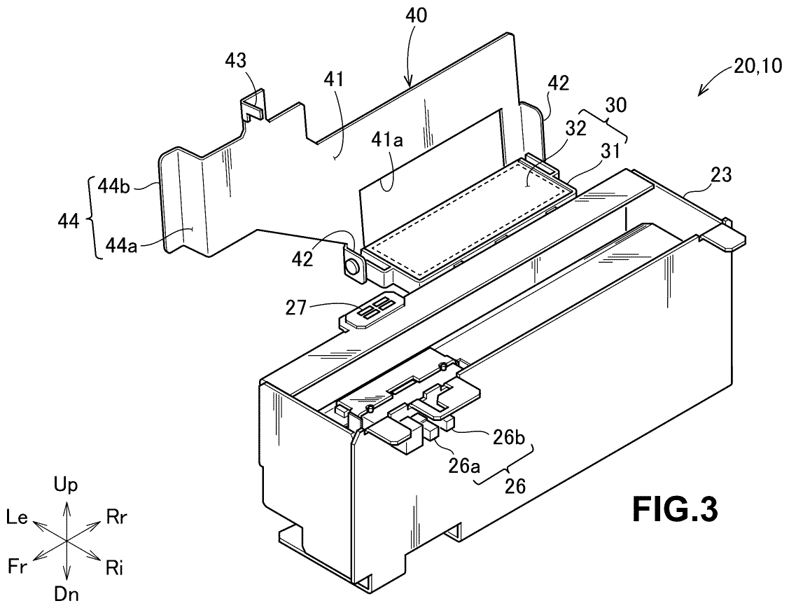

Referring to FIG. 2 and FIG. 3, the print unit 20 includes a plate portion 21 having a plate shape and provided with a plurality of openings; an ejection unit 22 that is movable to the left and right above the plate portion 21 and that is capable of ejecting the ink; a base portion 23 provided below the plate portion 21; an ink discharge unit 30 which is supported by the base portion 23 and to which the ink discharged from the ejection unit 22 is discharged; a lid 40 that is swingably supported by the ink discharge unit 30; a detection unit 26 capable of detecting that the lid 40 is in a closed state; a magnet 27 fixed to the base portion 23 and capable of coming into close contact with the lid 40 in the closed state; and a wiper unit 28 supported by the base portion 23 and capable of wiping off the ink adhering to the ejection unit 22.
Regarding Ejection Unit 22

The ejection unit 22 is capable of irradiating the ink with ultraviolet rays while moving the medium, which is a print target, to the left and right, and ejecting the ink onto the medium.
Regarding Ink Discharge Unit 30

The ink discharge unit 30 includes a discharge unit main body 31 fixed to the base portion 23 and supporting the lid 40, and an ink absorbing member 32 housed in the discharge unit main body 31 and capable of absorbing the ink.

A sponge or a non-woven fabric sheet can be used as the ink absorbing member 32. In addition, a plurality of these materials can also be used.
Regarding Lid 40

The lid 40 is made of, for example, a single metal plate. Ferritic or martensitic stainless steel can be used as the material of the lid 40. Although details will be described later, it is preferable that the material of the lid 40 is a material that can be attracted to the magnet 27.

The lid 40 includes a lid main body 41; hinge portions 42 formed by bending parts of the lid main body 41 and supported by the discharge unit main body 31; a detected portion 43 bent from the lid main body 41 toward the detection unit 26 and detected by the detection unit 26; an operating portion 44 formed by being bent from the lid main body 41 and intended for an operator to perform a swing operation.

In addition, when a material that is not attracted to a magnet is used as the material of the lid 40, an attraction portion that can be attracted to the magnet 27 may be provided on a portion of a back surface of the lid main body 41, the portion corresponding to the magnet 27. In this case, the lid can be made of austenitic stainless steel or resin.

The lid main body 41 is formed to be long in one direction, and an opening 41a to which a part of the ink absorbing member 32 is exposed is formed at one end of the lid main body 41. The hinge portions 42 are formed to interpose the opening 41a therebetween.

Particularly, as illustrated in FIG. 2, an edge of the opening 41a is located inside an edge 32a of the ink absorbing member 32 indicated by a broken line. Namely, the edge of the opening 41a overlaps the ink absorbing member 32 in a closed state.

The operating portion 44 is raised from the other end of the lid main body 41 in a substantially L shape. Namely, the hinge portions 42 and the opening 41a are formed at the one end of the lid main body 41 that is formed in an elongated shape, and the operating portion 44 is formed at the other end.

The operating portion 44 includes a raised portion 44a raised from the lid main body 41, and a knob portion 44b that extends from an upper end of the raised portion 44a and away from the lid main body 41 and that can be pinched by the operator.
Regarding Detection Unit 26

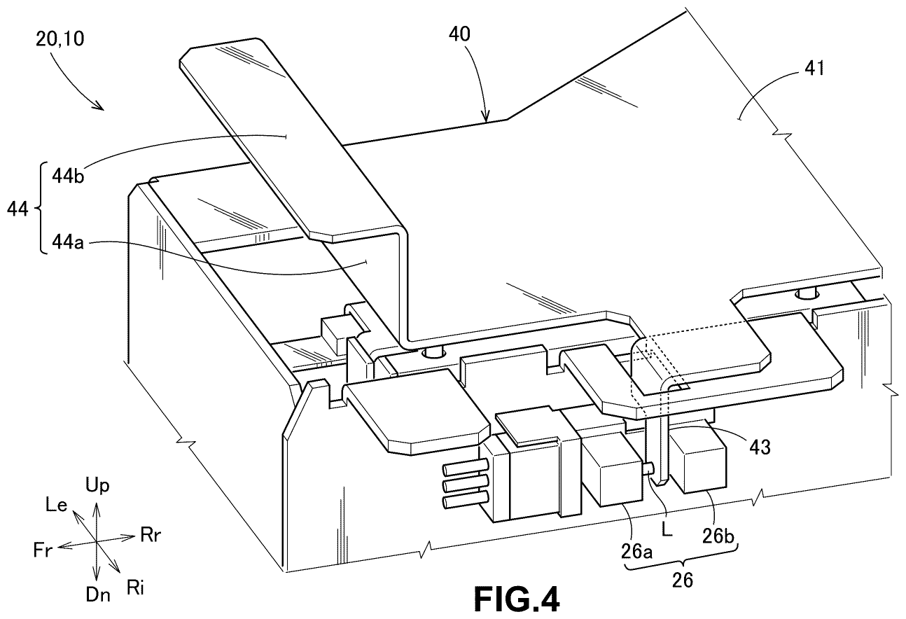

Referring to FIG. 4, a photointerrupter can be used as the detection unit 26. The detection unit 26 includes a light emitting unit 26a capable of emitting light L, and a light receiving unit 26b that receives the light L. When the detected portion 43 of the lid 40 blocks the light L emitted by the light emitting unit 26a, the detection unit 26 is capable of detecting that the lid 40 is closed. When the detected portion 43 does not block the light L, the light receiving unit 26b detects the light L emitted by the light emitting unit 26a, so that it is detected that the lid 40 is opened.

For example, the detection unit 26 is connected to a control unit (not illustrated). When a printing start signal is sent in a state where the lid 40 is opened, the control unit prohibits the ejection unit 22 (refer to FIG. 2) from operating until the lid 40 is closed. In addition, when it is detected that the lid 40 is opened during printing, the control unit stops the ejection unit 22.

The detection unit 26 may be a non-contact sensor other than a photointerrupter, or a contact sensor that detects a closed state when the detected portion 43 comes into contact with the contact sensor.
Regarding Magnet 27

Referring to FIG. 3, a permanent magnet that can be attracted to the lid main body 41 in a closed state can be used as the magnet 27. The attraction force of the magnet 27 can be set, for example, by the number of permanent magnets. The force required to open the lid 40 is moderate, and is set to a force that prevents the lid 40 from being opened due to vibration or the like in a closed state.
Regarding Wiper Unit 28

Referring to FIG. 2, the wiper unit 28 is a member for wiping off the ink adhering to an ejection surface (lower surface) of the ejection unit 22. A portion of the wiper unit 28 that comes into contact with the ejection unit 22 is made of, for example, rubber.

The wiper unit 28 can be displaced in an up-down direction and a front-rear direction. An upper end of the wiper unit 28 is capable of coming into contact with the ink ejection surface of the ejection unit 22 in a raised state. When the upper end of the wiper unit 28 is raised to the same height as the ink ejection surface and the ejection unit 22 is displaced in a left-right direction, the wiper unit 28 comes into contact with the ejection unit 22, and the ink adhering to the ejection surface is wiped off by the wiper unit 28.

In addition, the upper end of the wiper unit 28 can be lowered to a position lower than a lower surface of the lid 40. The wiper unit 28 can be moved to a position covered by the lid 40 by being moved forward in a lowered state.
Action of Printer Device 10

Referring to FIG. 3 as well, when the ink adhering to the ejection unit 22 hardens, the hardened ink may hinder the ejection of the ink. For this reason, during use of the printer device 10, the ink is discharged from the ejection unit 22 to the ink discharge unit 30 under predetermined conditions. When the discharge of the ink is performed a predetermined number of times, a large amount of the ink adheres to and is cured on the ink absorbing member 32. For this reason, the replacement of the ink absorbing member 32 is required.

The operator rotates the lid 40 by pinching and lifting the operating portion 44. By rotating the lid 40, an upper portion of the ink absorbing member 32 is opened, and the ink absorbing member 32 can be replaced.

After the ink absorbing member 32 is replaced, the operator closes the lid 40. When the detection unit 26 detects the detected portion 43 and detects that the detected portion 43 is in a closed state, printing can be performed again.

### Second Embodiment

Next, a printer device 10A according to a second embodiment will be described based on the drawings.

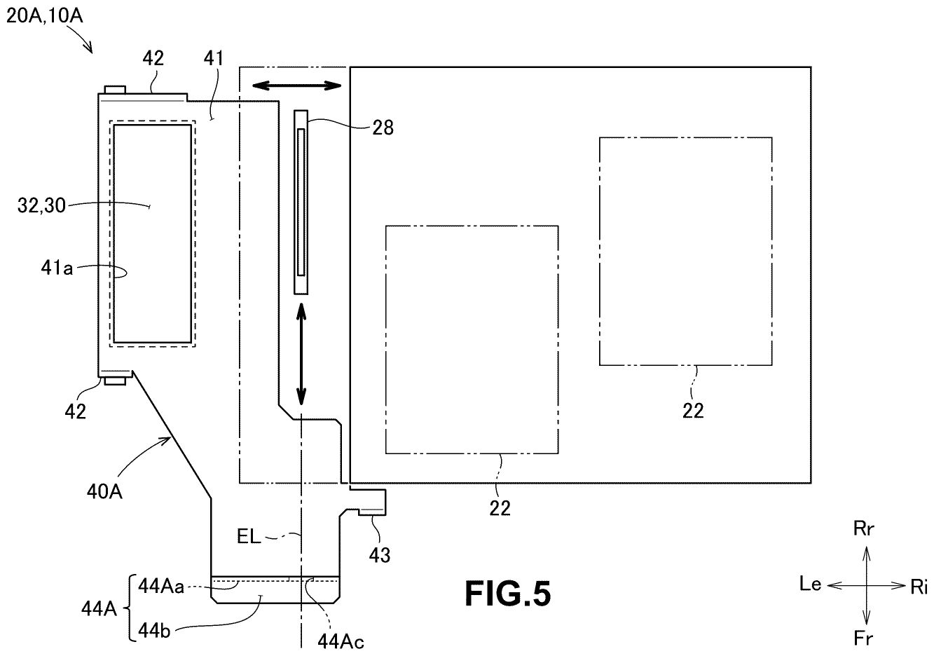

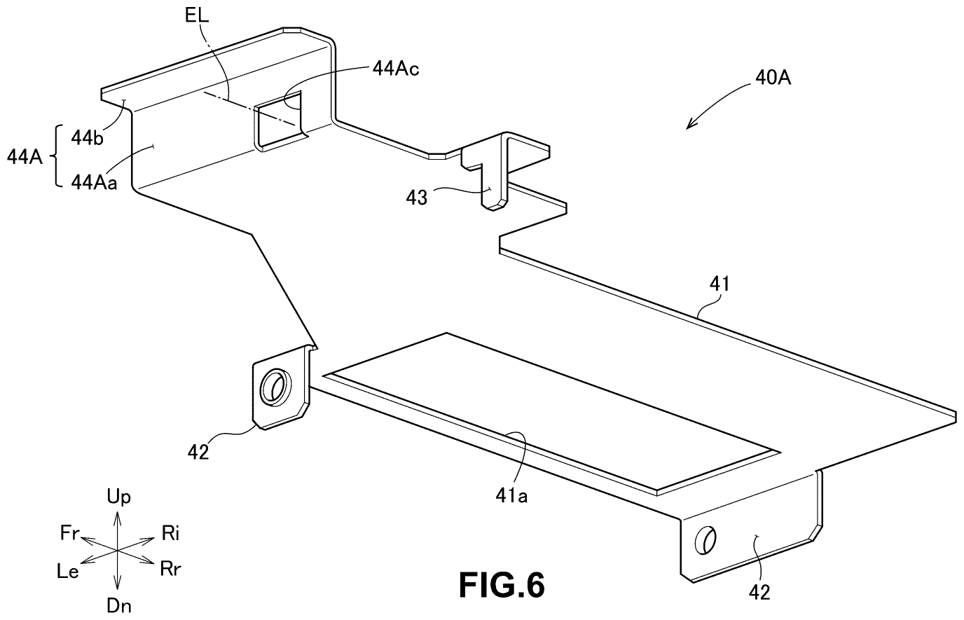

Referring to FIG. 5 and FIG. 6, FIG. 5 illustrates the state of a print unit 20A of the printer device 10A according to the second embodiment when viewed from above. In addition, FIG. 6 is a perspective view illustrating the state of a lid 40A used in the printer device 10A when viewed diagonally from below. Reference letters or numerals are reused for portions common to the first embodiment, and detailed description thereof will be omitted.

The lid 40A includes a raised portion 44Aa raised from the lid main body 41, and the knob portion 44b that extends from an upper end of the raised portion 44Aa and away from the lid main body 41 and that can be pinched by the operator. The raised portion 44Aa and the knob portion 44b are collectively referred to as an operating portion 44A. A part of the raised portion 44Aa is located on an extension line EL of a movement direction of the wiper unit 28 in the front-rear direction (horizontal direction).

A raised portion opening 44Ac having a substantially rectangular shape is provided in the raised portion 44Aa at a position overlapping the extension line EL.

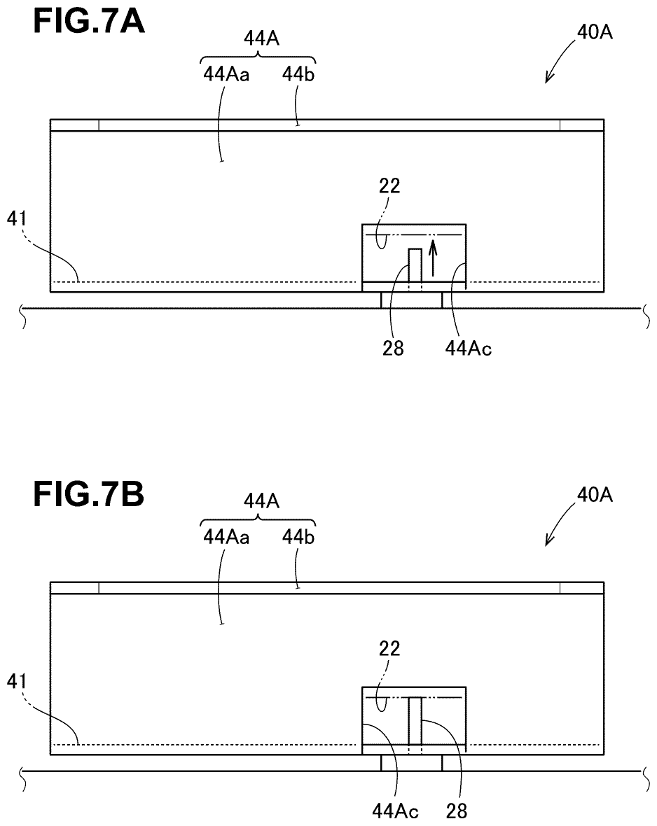

Referring to FIG. 7A, the upper end of the wiper unit 28 in a raised state is visible from the raised portion opening 44Ac. In addition, an upper end of the raised portion opening 44Ac is located above a lower end of the ejection unit 22.

Even when the wiper unit 28 is located at a rise end as the ejection unit 22 is repeatedly wiped by the wiper unit 28, the upper end of the wiper unit 28 may not reach a wiping surface of the ejection unit 22. In such a case, it is necessary to adjust the up-down position of the wiper unit 28. Well-known means and mechanism for performing adjustment can be adopted.

Referring to FIG. 7B as well, the position of the wiper unit 28 is adjusted by moving the ejection unit 22 to above the wiper unit 28 and raising the position of the upper end of the wiper unit 28 to a position where the upper end of the wiper unit 28 comes into contact with the ejection surface of the ejection unit 22. At this time, whether or not the height of the wiper unit 28 is appropriate is determined by viewing from the raised portion opening 44Ac.

The printer devices 10 and 10A described above will be summarized.

Referring to FIG. 3 and FIG. 5, according to a first aspect, the printer devices 10 and 10A include the base portion 23; the ink discharge unit 30 which is provided on the base portion 23 and to which ink is discharged; and the lids 40 and 40A that cover the ink discharge unit 30. The ink discharge unit 30 includes the ink absorbing member 32 capable of absorbing the discharged ink. The lids 40 and 40A include the opening 41a formed to allow at least a part of the ink absorbing member 32 to be exposed, and is provided to be swingable with respect to the ink absorbing member 32.

The lids 40 and 40A that cover the ink discharge unit 30 are provided to be swingable with respect to the ink absorbing member 32. The ink absorbing member 32 can be made replaceable by swinging the lids 40 and 40A. The ink absorbing member 32 can be easily replaced compared to when the lid is fixed using a fastening member such as a screw. Namely, it is possible to provide the printer devices 10 and 10A with high maintainability.

According to a second aspect, in the printer devices 10 and 10A of the first aspect, the base portion 23 is provided with a magnet 27 capable of coming into close contact with the lids 40 and 40A to keep the lids 40 and 40A in a closed state. The swinging of the lids 40 and 40A due to vibration or the like during use of the printer devices 10 and 10A can be suppressed.

Referring to FIG. 2 and FIG. 6, according to a third aspect, in the printer devices 10 and 10A of the first or second aspect, the edge of the opening 41a overlaps the ink absorbing member 32 in a closed state. For this reason, the lifting of the ink absorbing member 32 can be suppressed.

According to a fourth aspect, in the printer devices 10 and 10A of any one of the first to third aspects, the lids 40 and 40A include the operating portions 44 and 44A for an operator to perform a swing operation. The operability of the lid 40 can be improved, and the printer device 10 with higher maintainability can be provided.

Referring to FIG. 4 and FIG. 6, according to a fifth aspect, in the printer devices 10 and 10A of any one of the first to fourth aspects, the base portion 23 is provided with the detection unit 26 capable of detecting that the lids 40 and 40A are in a closed state. In addition, the lids 40 and 40A include the detected portion 43 detected by the detection unit 26 in the closed state. Accordingly, the ejection unit 22 can be prevented from operating in a state where the lids 40 and 40A are opened.

Referring to FIG. 2 and FIG. 5, according to a sixth aspect, the printer devices 10 and 10A of any one of the first to fifth aspects include the ejection unit 22 capable of ejecting the ink, and the base portion 23 is provided with the wiper unit 28 capable of wiping off the ink adhering to the ejection unit 22. In addition, the lids 40 and 40A are also capable of covering the wiper unit 28.

The lids 40 and 40A can cover the wiper unit 28 as well as the ink absorbing member 32. A plurality of members can be covered with one member, and the number of components can be reduced. Accordingly, the printer devices 10 and 10A can be made inexpensive.

Referring to FIG. 5, FIG. 6, and FIG. 7A, according to a seventh aspect, the printer device 10A of any one of the first to sixth aspects further includes the ejection unit 22 capable of ejecting the ink. The base portion 23 (refer to FIG. 3) is provided with the wiper unit 28 capable of wiping off the ink adhering to the ejection unit 22. The wiper unit 28 is movable up and down, and is movable in a horizontal direction. The lid 40A includes the raised portion 44Aa extending in the up-down direction on the extension line EL of the movement direction of the wiper unit 28 in the horizontal direction. The raised portion 44Aa is provided with the raised portion opening 44Ac through which the wiper unit 28 in a raised state is visible.

The printer device 10A includes the wiper unit 28 for wiping off the ink adhering to the ejection unit 22. As the ejection unit 22 is repeatedly wiped by the wiper unit 28, the position of the wiper unit 28 in the up-down direction needs to be adjusted. The raised portion opening 44Ac is formed in the raised portion 44Aa located on the extension line of the movement direction of the wiper unit 28 in the horizontal direction. The tip of the wiper unit 28 is visible from the raised portion opening 44Ac, and the position of the wiper unit 28 in the up-down direction can be adjusted with the lid 40A closed. The maintainability of the printer device 10A can be improved.

Referring to FIG. 7A, according to an eighth aspect, in the printer device 10A of the seventh aspect, the upper end of the raised portion opening 44Ac is located above the lower end of the ejection unit 22. The lower end of the ejection unit 22 is horizontally visible, and the tip of the wiper unit 28 can be disposed at a more appropriate position.

Incidentally, the invention has been described using a UV printer as an example, but can also be applied to printer devices other than the UV printer. In addition, the invention can also be applied to a printer device including only the print unit 20.

The invention is not limited to the embodiments as long as the actions and effects of the invention are exhibited.

### INDUSTRIAL APPLICABILITY

The printer device of the invention is suitable for a UV printer.

### Explanations of Letters or Numerals

10, 10A PRINTER DEVICE
22 EJECTION UNIT
23 BASE PORTION
26 DETECTION UNIT
27 MAGNET
28 WIPER UNIT
30 INK DISCHARGE UNIT
32 INK ABSORBING MEMBER
40, 40A LID
41a OPENING
43 DETECTED PORTION
44, 44A OPERATING PORTION, 44Aa RAISED PORTION, 44Ac RAISED PORTION OPENING
EL EXTENSION LINE

1. A printer device comprising:
a base portion;
an ink discharge unit which is provided on the base portion and to which ink is discharged; and
a lid that covers the ink discharge unit,
wherein the ink discharge unit includes an ink absorbing member capable of absorbing the discharged ink, and
the lid includes an opening formed to allow at least a part of the ink absorbing member to be exposed, and is provided to be swingable with respect to the ink absorbing member.

2. The printer device according to claim 1,
wherein the base portion is provided with a magnet capable of coming into close contact with the lid to keep the lid in a closed state.

3. The printer device according to claim 1,
wherein an edge of the opening overlaps the ink absorbing member in a closed state.

4. The printer device according to claim 1,
wherein the lid includes an operating portion for an operator to perform a swing operation.

5. The printer device according to claim 1,
wherein the base portion is provided with a detection unit capable of detecting that the lid is in a closed state, and
the lid includes a detected portion detected by the detection unit in the closed state.

6. The printer device according to claim 1, further comprising:
an ejection unit capable of ejecting the ink,
wherein the base portion is provided with a wiper unit capable of wiping off the ink adhering to the ejection unit, and
the lid is also capable of covering the wiper unit.

7. The printer device according to claim 1, further comprising:
an ejection unit capable of ejecting the ink,
wherein the base portion is provided with a wiper unit capable of wiping off the ink adhering to the ejection unit,
the wiper unit is movable up and down, and is movable in a horizontal direction,
the lid includes a raised portion extending in an up-down direction on an extension line of a movement direction of the wiper unit in the horizontal direction, and
the raised portion is provided with a raised portion opening through which the wiper unit in a raised state is visible.

8. The printer device according to claim 7,
wherein an upper end of the raised portion opening is located above a lower end of the ejection unit.
